(19) United States
(12) Patent Application Publication
(10) Pub. No.: US 2017/0113957 A1
(43) Pub. Date: Apr. 27, 2017

(54) SYSTEMS AND METHODS FOR REDUCTION OF TOTAL ORGANIC COMPOUNDS IN WASTEWATER

(71) Applicant: Nicholas Eckelberry, Los Angeles, CA (US)

(72) Inventor: Nicholas Eckelberry, Los Angeles, CA (US)

(21) Appl. No.: 15/172,010

(22) Filed: Jun. 2, 2016

Related U.S. Application Data
(60) Provisional application No. 62/171,484, filed on Jun. 5, 2015.

(51) Int. Cl. C02F 9/00; C02F 1/00

(52) U.S. Cl. CPC C02F 9/00; C02F 1/008; C02F 1/465

(57) ABSTRACT

A system for purifying wastewater comprising the reduction of total organic compounds in wastewater is disclosed. Chemical reducing agents are brought into contact with polluted water and through dynamically stable anode induced electro-coagulation and flotation removing natural organic material and biorefractory pollutants, decreasing competing organic matter for a secondary oxidizing step, where acids oxidize the processed wastewater through series of reactor tubes for the reduction of total organic compounds.

### CROSS-REFERENCE TO RELATED APPLICATIONS

This application claims priority to U.S. Provisional Patent Application No. 62/170,637 (Attorney Docket No. 18990.134), filed Jun. 3, 2015, titled “SYSTEMS AND METHODS FOR BASE AND ACID REACTION FOR EXTRACTION”; and claims priority to U.S. Provisional Patent Application No. 62/171,484 (Attorney Docket No. 18990.155), filed Jun. 6, 2015, titled “SYSTEMS AND METHODS FOR BASE AND ACID REACTION FOR EXTRACTION”; and claims priority to U.S. Provisional Patent Application No. 62/275,116 (Attorney Docket No. 18990.157), filed Jan. 5, 2016, titled “SYSTEMS AND METHODS FOR REDUCTION OF TOTAL ORGANIC COMPOUNDS IN WASTEWATER”. This application is a continuation-in-part of U.S. patent application Ser. No. 14/109,336 (Attorney Docket No. 18990.66), filed Dec. 17, 2013, titled “Removing Compounds from Water Using a Series of Reactor Tubes Containing Cathodes Comprised of Mixed Metal Oxide”; and is a continuation-in-part of U.S. patent application Ser. No. 13/942,348 (Attorney Docket No. 18990.63), filed Jul. 15, 2013, titled “Removing Ammonia from Water”; and is a continuation-in-part of U.S. patent application Ser. No. 13/872,044 (Attorney Docket No. 18990.62), filed Apr. 26, 2013, titled “Producing Algae Biomass Having Reduced Concentration Of Contaminants”; and is a continuation-in-part of U.S. patent application Ser. No. 13/865,097 (Attorney Docket No. 18990.60), filed Apr. 17, 2013, titled “Harvesting And Dewatering Algae Using A Two-Stage Process”; and is a continuation-in-part of U.S. patent application Ser. No. 13/753,484 (Attorney Docket No. 18990.58), filed Jan. 29, 2013, titled, “Systems And Methods For Harvesting And Dewatering Algae”; and claims priority to U.S. Provisional Patent Application No. 61/592,522 (Attorney Docket No. 18990.44), filed Jan. 30, 2012, titled “Systems And Methods For Harvesting And Dewatering Algae”.

Through U.S. patent application Ser. No. 13/865,097, this application also claims priority to U.S. Provisional Patent Application No. 61/625,463 (Attorney Docket No. 18990.47), filed Apr. 17, 2012, titled “Solute Extraction From An Aqueous Medium Using A Modular Device”; and to U.S. Provisional Patent Application No. 61/649,083 (Attorney Docket No. 18990.48), filed May 28, 2012, titled “Modular Systems And Methods For Extracting A Contaminant From A Solution”. This application claims the benefit of these two provisional applications.

This application also claims priority to U.S. Provisional Patent Application No. 61/945,687 (Attorney Docket No. 18990.69), filed Feb. 27, 2014, titled “An Electrocatalytic Process for Coalescing and Skimming Pollutants in Bodies of Water Prior to Filtration”.

This application also claims priority to U.S. patent application Ser. No. 14/543,457 (Attorney Docket No. 18990.95), filed Nov. 17, 2014, titled “System for Removal of Suspended Solids and Disinfection of Water”.

The disclosure of each of the applications to which the present application claims priority are incorporated by reference.

### BACKGROUND

Total organic carbon (TOC) is the amount of carbon found in an organic compound and is often used as a non-specific indicator of water quality, or cleanliness of pharmaceutical manufacturing equipment. TOC in source water comes from decaying natural organic matter (NOM) as well as synthetic sources. Humic acid, fulvic acid, amines, and urea are examples of NOMs. Some detergents, pesticides, fertilizers, herbicides, industrial chemicals, and chlorinated organics are examples of synthetic sources.

Before source water is treated for disinfection, TOC analysis provides an estimate of the amount of NOM in the water source. In water treatment facilities, source water is subject to reaction with chloride containing disinfectants. When the raw water is chlorinated, active chlorine compounds (Cl₂, HOCl, and ClO⁻) react with NOM to produce chlorinated disinfection byproducts (DBPs). Researchers have determined that higher levels of NOM in source water during the disinfection process will increase the amount of DBP related carcinogens in the processed drinking water. Prior to effluent discharge from wastewater treatment plants (WWTPs), chlorine applied in the last disinfection step has an extremely high potential to transform the humic-like substances to a variety of disinfection byproducts (DBPs), including EPA regulated trihalomethanes (THMs) and haloacetic acids (HAAs), and unregulated N-containing DBPs such as haloacetamides (HAcAms) and N-Nitrosodimethylamine (NDMA). Many DBPs are cancerogenic, mutagenic, and/or genotoxic. Because treated wastewater represents a significant fraction of water flow in many rivers, discharge of leachate into WWTPs can result in the exposure of humans, other mammalian species, and aquatic organisms to the DBPs. Additionally, the drinking water supply of some communities is taken from rivers subjected to significant upstream wastewater effluent discharges containing significant amounts of emerging organic pollutants. Consequently, quantification of the formation potentials of DBPs contributed from leachate organic matters is critical.

While many systems have evolved for the removal of NOM and biorefractory aqueous pollutants prior to disinfection with Chlorine compounds such as Dissolved Air Flotation (DAF), Dissolved Gas Flotation (DGF), filtration, settling, Anaerobic Digestion (AD), all of these have shown limitations in large scale applications where thousands of gallons of water need to be processed in a timely and economical manner. In DAF or DGF, for example, scale inefficiencies are brought about due to poor contact between chemicals and water as it is a relatively passive system that relies on injected gases to bring about contact between chemicals and water. AD is a powerful method that relies on microbial activity to lower TOC; this system however is heat dependent and shows loss of efficiency in colder weather. Other systems such as membrane filtration rapidly get overwhelmed and need constant attention and replacement.

The challenge is to remove NOM effectively without the addition of chlorine so as to mitigate the generation of DPBs. Once the waste stream NOM content is reduced, mechanisms such as breakpoint chlorination can be utilized to break ammonia bonds or otherwise completely sterilize the water without undue generation of DPBs in sludge.

### BRIEF SUMMARY

The present disclosure is generally directed to methods and systems for purifying wastewater comprising the reduction of total organic compounds in wastewater. Some embodiments of a method for reducing total organic compounds in wastewater, comprise a two-step water remediation process comprising first reducing an influent waste stream of water containing Natural Organic Matter (NOM), and subsequently oxidizing the water to achieve a substantial reduction in Total Organic Compounds present in effluent water. In some embodiments polluted water is brought into contact with a chemical reducing agent, through a static mixer promoting transient cavitation and high mass transfer coefficient between solvent and solute. In some embodiments, the solution of polluted water and chemical reducing agent then flow through a reactor tube. In preferred embodiments, the reactor tube comprises a concentrically related anode and cathode, wherein the exposed surface of the cathode is composed of a metal sheath, and wherein the anode comprises a mixed metal oxide coated surface. In some embodiments, after initial treatment in reaction tube, the wastewater effluent flows into a flotation tank and/or oxidation chamber comprising an electrode array producing gaseous microbubbles and reactive oxygen species, are generated as electric current flows, between the anode and cathode, and through the solution of polluted water, for collection of organic waste material or sludge. In some embodiments, the supernatant is then allowed to flow through a secondary apparatus, comprising a static mixer that blends a strong acid with the oxidized product, which is then allow to flow through a second reactor tube, and disgorged into a secondary recovery tank flotation tank and/or oxidization chamber for harvesting of soluble organic compounds or sludge. In some embodiments, due to the significant removal of TOC, the treated effluent water can then be additionally purified through additional conventional means, for example filtration or reverse osmosis.

The present disclosure is generally directed to methods and systems purifying wastewater comprising reducing total organic compounds in wastewater. In some embodiments the system for reducing total organic compounds in wastewater comprises a two stage system to lower Natural Organic Matter (NOM) prior to oxidation. In some embodiments, the influent comprises a suspension of microalgae in growth media. In some embodiments, influent wastewater is pretreated to remove large particulates. In some embodiments the pretreatment stage may comprise a screw press, clarifiers, settling tanks, and/or sand filtration. In some embodiments, after the pretreatment stage, the grossly filtered product is then entrained into a mixing tank, which may comprise of modifiers, for example coagulants and pH modifiers, which are brought into contact with the water. In some embodiments, the mixed product is entrained by pump, or passively through a static mixer through a reactor tube, comprising mixed metal oxide (MMO) based anode and cathode reactors. In some embodiments, after flowing through at least one reactor tube, the mixed product is then entrained to the organics removal (NOM) flotation tank and/or oxidation chamber, wherein the organics removal flotation tank and/or oxidation chamber comprises at least one anode and cathode, or a configuration of an anode array and cathode array, effectively separating organic sludge from effluent water. In some embodiments the dewatered sludge, may be moved to an anaerobic digester, and in some embodiments, the effluent treated aqueous solution is subsequently filtered through a combination of media filters and/or ultra-filtration. In some embodiments, the dewatered microalgae may be harvested for its beneficial applications. In some embodiments, the treated and filtered aqueous effluent solution is held in storage or buffer tank, wherein the treated and filtered aqueous effluent solution is entrained through a pump to a static mixer structured to mix a strong acid, into the filtered aqueous effluent solution effectively producing reduced effluent aqueous product. In some embodiments, the effluent solution may comprise a growth media that may be returned or diluted with fresh media. In some embodiments, the reduced effluent solution is further processed by allowing the reduced solution to flow through a reactor tube, a series of reactor tubes, and/or oxidizing arrays. In some embodiments, after flowing through the at least one reactor tube, the effluent solution may be disgorged into an oxidation chamber, comprising at least one anode and cathode, and preferably comprising a series of electrocatalytic MMO anodes. In some embodiments, movement through the oxidization chamber separates clarified water from solid byproducts, wherein the solid products (sludge) may be returned to an anaerobic digester, and the effluent water may be fed into a sequence of media, and/or ultra-filtration systems, for example reverse osmosis, whereby the final effluent water meets discharge quality standards.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates a cross-sectional front view of embodiments of a reactor tube containing an inner electrode sheathed by an outer electrode;

FIG. 1B illustrates a cross-sectional side view of embodiments of a reactor tube;

FIG. 2A illustrates a cross-sectional front view of embodiments of a reactor tube containing an inner electrode sheathed by an outer electrode with apertures;

FIG. 2B illustrates a cross-sectional side view of embodiments of a reactor tube containing an inner electrode sheathed by an outer electrode with apertures;

FIG. 3 illustrates a perspective view of embodiments of a reactor tube containing an inner electrode sheathed by an outer electrode with apertures;

FIG. 4 illustrates embodiments of a reactor tube array;

FIG. 5 illustrates embodiments of a two-stage flocculation and flotation system for reducing total organic compounds in wastewater and/or dewatering microalgae;

FIGS. 6A-6D illustrate embodiments of a two-stage flocculation and flotation system as the system removes total organic compounds in wastewater and/or dewaters microalgae;

FIGS. 7A and 7B illustrate embodiments of a multi-chambered flotation system for reducing total organic compounds in wastewater and/or dewatering microalgae;

FIG. 8 illustrates embodiments of methods for dewatering microalgae; and

FIG. 9 illustrates a schematic of the flow through an embodiment of a water remediation system.

### DETAILED DESCRIPTION

In U.S. patent application Ser. Nos. 13/753,484, 13/865,097, and 13/872,044, to which this application claims priority, embodiments were disclosed for a two-stage approach for harvesting algae. This two-stage approach includes a first stage flocculation tank which employs electrodes. In the prior application Ser. No. 13/942,348, reactor tubes similar to the flocculation tank described in Ser. Nos. 13/872,044 and 13/865,097 are employed in series to generate hypochlorite for breaking down ammonia in wastewater flowed through the reactor tubes.

Furthermore in U.S. patent application Ser. Nos. 13/942,348, 13/872,044, 13/865,097, and 14/109,336, to which this application claims priority, embodiments were disclosed for removing ammonia from wastewater using electrodes made of a titanium ruthenium alloy or mixed metal oxide anodes (e.g. titanium core anodes having a coating of a metal in the platinum family such as ruthenium or iridium).

The present application is generally directed to a system or method utilizing reduction and oxidation reactions to reduce total organic compounds in wastewater. First, general embodiments of systems and methods for reduction of total organic compounds in wastewater are described. Second, specific embodiments of electrode assemblies including comprising materials and embodiments of configurations are identified. Next, embodiments of configurations of systems that can utilize the disclosed electrode assemblies to purify wastewater, remove organic compounds from wastewater harvest, and/or dewater microalgae are disclosed. Lastly, embodiments of systems that integrate configurations of systems that can utilize the disclosed electrode assemblies within systems and methods to purify wastewater, remove organic compounds from wastewater harvest, and/or dewater microalgae are disclosed.

Because the treatment of water and wastewater has become a more challenging issue due to the ineffective degradation of pollutants by conventional treatments which rely on biological process, research utilizing mixed metal oxides (MMOs) for electrochemical oxidation of recalcitrant pollutants in aqueous environment should be performed. In general, MMO anodes may be used to decrease aqueous pollution caused by recalcitrant organics, even for those which have extraordinary strong C—F bonds (490 kJ mol-1). If appropriate MMO anodes are chosen and the operating conditions are suitable for electrochemical oxidation, most recalcitrant organics can be completely removed or alleviated to their acceptable levels before biological treatment. For practical application of electrochemical oxidation treatment, one of the important considerations is the change of toxicity of treated wastewater, due to the nature of diverse compounds in real industrial wastewaters. Though studies have confirmed the improvement of biodegradability in treating specific biorefractory aqueous pollutants, wastewaters containing halogenated compounds present different challenges, such as reactive oxygen species (ROS) concentrate. The transformation of organic compounds to their halogenated derivatives involving —Cl and —Br substituents in the organic molecule are expected to augment significantly the toxicological properties. The byproducts formed can be very problematic and the toxicity can increase by a factor of even 40-60 times, which represents a barrier to the environmental application of MMO anodes. Such observations were usually reported in active MMO anodes, of which the oxidation power was not sufficient to fully degrade the halogenated byproducts. Therefore, with MMO anodes, careful design of electrochemical operation is crucial to the success of its application.

It was discovered that by utilizing electrified Multiple Metal Oxides with reducing chemical agents to separate humic-like substances from water prior to oxidation with Multiple Metal Oxides with a strong acid, reduced the amount of DPBs produced in both the sludge and water in a TOC reducing process.

Consequently, the present application generally discloses a two stepped water remediation process consisting of first reducing a waste stream of natural organic matter (NOM) and then oxidizing the water in order to achieve a substantial reduction in total organic compounds (TOC). Polluted water 902 is brought into contact with the chemical reducing agent 903 through a static mixer 904 promoting transient cavitation and high mass transfer coefficient between solvent and solute. The product then flows through a tubular reactor 300 or 400 whose outer surface is composed of a metal sheath acting as cathode 320 or 420 and multiple metal oxides coated electrified anode rod or tube promoting the generation of bubbles and reactive oxygen species that are then disgorged into a flotation tank 906, 600 or 734 for collection of organic waste material or sludge. The supernatant is then flowed through a secondary apparatus 910, 911, 902a, 904 and 600 where it is brought into contact through a static mixer 904 that blends in a strong acid 913, and the oxidized product is then flowed through a reactor tube/oxidizer array 905, 1200, 300 or 400 and disgorged into a secondary recovery tank, or oxidization chamber 602, 702, 734, 744, or 914 for harvesting of soluble organic compounds or sludge. Due to the significant removal of TOC, the water can now be practically polished through conventional means such as filtration or reverse osmosis 910a, 910, and/or 915.

The present disclosure is generally directed to methods and systems for reducing total organic compounds in wastewater. In some embodiments the system for reducing total organic compounds in wastewater comprises a two-stage system to lower Natural Organic Matter (NOM) prior to oxidation. In some embodiments, influent wastewater is pretreated 901 to remove large particulates. In some embodiments the pretreatment stage 901 may comprise a screw press, clarifiers, settling tanks, sand filtration. In some embodiments, the influent 902 or 605 comprises a suspension of microalgae in growth media. In some embodiments, after the pretreatment stage 901 the grossly filtered product is then entrained to a mixing tank 904, which may comprising modifiers, for example coagulants and pH modifiers 903, which are brought into contact with the water. In some embodiments, the mixed product is entrained by pump 918 through a static mixer 904 through at least one, or a series or reactor tubes 905, 300, or 400, comprising mixed metal oxide (MMO) based anode and cathode reactors 300, 400 or 905. In some embodiments, after flowing through at least one reactor tube 300, 400 or 905, the mixed product is then entrained to the organics removal (NOM) flotation tank 600, 602, 702, 734 or 906, wherein the organics removal flotation tank 600, 602, 702, 734 or 906 comprises at least one anode and cathode, or a configuration of an anode array and cathode array 1200, effectively separating organic sludge from effluent water. In some embodiments the dewatered sludge 907, may be moved to an anaerobic digester 908, and in some embodiments the effluent treated aqueous solution 909 is filtered through a combination of media filters and/or ultra-filtration 910 and/or 911. In some embodiments, the dewatered sludge 907 or microalgae 660 may be harvested for its beneficial applications. In some embodiments, the treated and filtered aqueous effluent solution 909 is held in storage or buffer tank 902a, wherein the treated and filtered aqueous effluent solution is entrained through a pump 920 to a static mixer 904 structured to mix an acid 913, for example HCL, effectively producing reduced effluent aqueous product. In some embodiments, the reduced effluent solution is further processed by allowing the reduced solution to flow through a reactor tube 300 or 400, a series of reactor tubes, or an oxidizing arrays 905. In some embodiments, after flowing through at least one reactor tube 300, 400, or 905, the effluent solution may be disgorged into a oxidation chamber 602, 702, 734, 744, or 914, comprising at least one anode and cathode, and preferably comprising a series of electrocatalytic mixed metal oxide anodes 1200 In some embodiments, movement through the oxidization chamber 744 and/or 914 separates clarified water from solid byproducts, wherein the solid products (sludge) 907 may be returned to an anaerobic digester 908, and the effluent water may be fed into a sequence of media, and/or ultra-filtration systems 910a, 910 and/or 909a, for example reverse osmosis 915, whereby the final effluent water 916 meets discharge quality standards. In some embodiments, the resulting effluent solution may comprise a growth media that may be returned or subsequently diluted with fresh growth media.

Electrode Assemblies

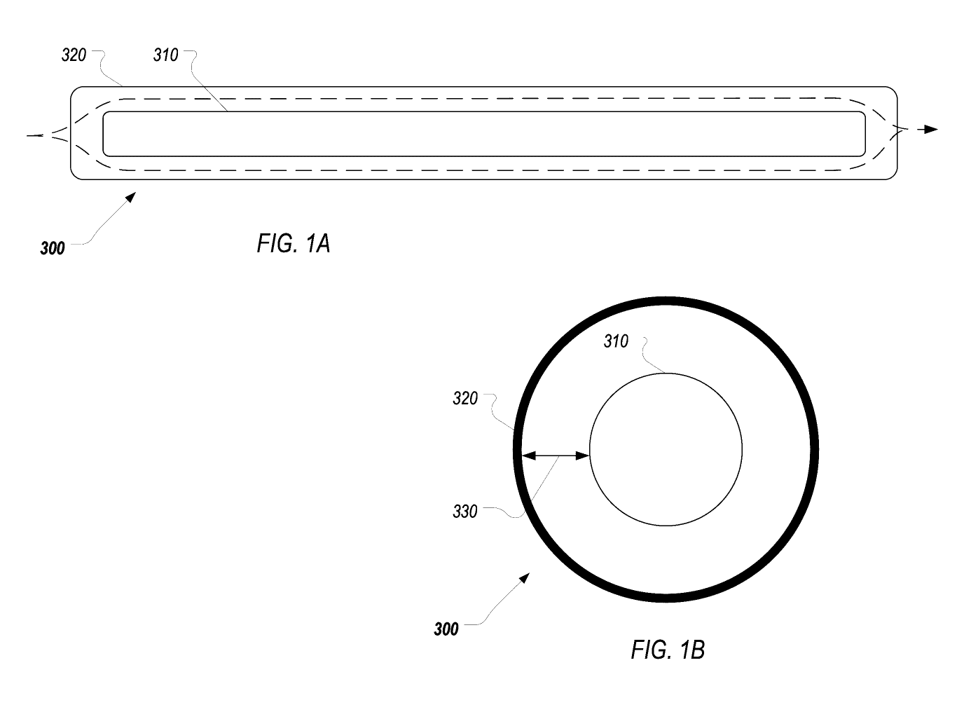

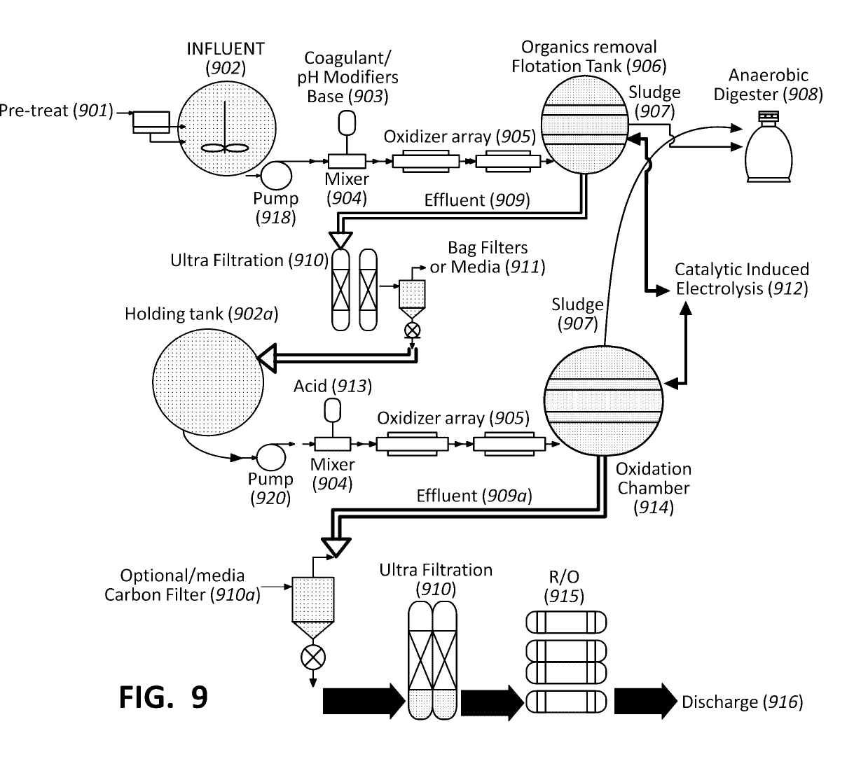

FIGS. 1A and 1B illustrate embodiments of reactor tube 300 as disclosed in prior application Ser. No. 13/865,097 or 905 as illustrated in FIG. 9. FIG. 1A illustrates a side view of embodiments of a reactor tube 300, 905. The reactor tube 300 can comprise an inner electrode 310 configured to be sheathed by an outer electrode 320. The outer electrode 320 can be configured as an enclosed pipe or tube. The inner electrode 310 can be configured as a solid rod or an enclosed pipe or other cylindrical shape that is contained within the outer cylinder. Accordingly, wastewater, and/or a suspension of microalgae in growth media can flow between inner electrode 310 and outer electrode 320. The inner electrode 310 and the outer electrode 320 can be configured as other shapes as long as some type of fluid pathway is formed between the two components. In some embodiments, the surface(s) of the inner electrode 310 and/or the outer cathode 320 that contact the wastewater and/or suspension of microalgae in growth media can include grooves, rifling, ridges, bumps, or other structures to decrease the occurrence of build-up on the surfaces and or to increase vortexing flow of the suspension through the reactor tube 300, 905.

FIG. 1B and FIG. 9 illustrate a cross-sectional side view of the reactor tube 300, 905. As shown, a spacing 330 exists between the inner electrode 310 and the outer electrode 320 through which the wastewater and/or suspension of microalgae in growth media flows. In some embodiments, this spacing 330 can be between about 0.5 mm and about 200 mm. In other embodiments, the spacing 330 can be between about 1 mm and about 9 mm. As a voltage differential is applied between the inner electrode 310 and the outer electrode 320, the electrical current can pass through the suspension of wastewater and/or microalgae in growth media and reactions such as flocculation, hydrolysis, and electrolysis can occur.

In some embodiments the inner electrode 310 is configured as an anode and the outer electrode 320 is configured as a cathode. In another embodiment, the inner electrode 310 is configured as a cathode and the outer electrode 320 is configured as an anode. In yet other embodiments, the electrodes 310, 320 can be configured as non-donating electrodes.

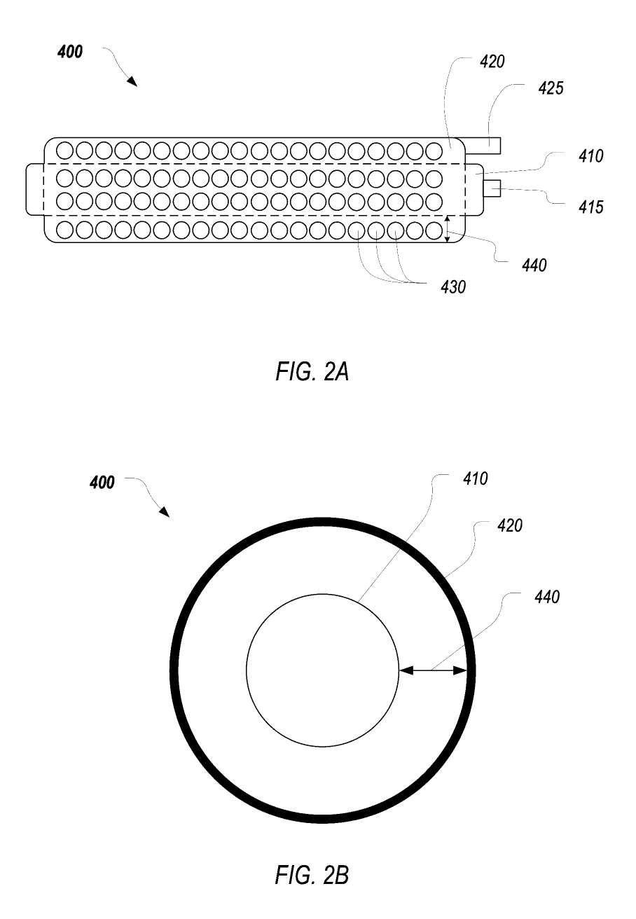

FIGS. 2A-2B and FIG. 9 illustrate side and cross-sectional views of embodiments of an electrode assembly 400, 906. As shown in FIG. 2A, some embodiments of the electrode assembly 400 can comprise an inner electrode 410 and an outer electrode 420. The outer electrode 420 can be configured to sheath the inner electrode 410. The outer electrode 420 can comprise a plurality of apertures 430. The inner electrode 410 and the outer electrode 420 can be configured such that a spacing 440 is maintained between the inner electrode 410 and the outer electrode 420. The inner electrode 410 can further comprise an inner electrode connector 415 configured to be connected to a power supply. The outer electrode 420 can further comprise an outer electrode connector 425 configured to be connected to a power supply. FIG. 2B shows a cross-sectional view of some embodiments of the electrode assembly 400. Cross-sectional views of the inner electrode 410, the outer electrode 420, and the spacing 440 are shown.

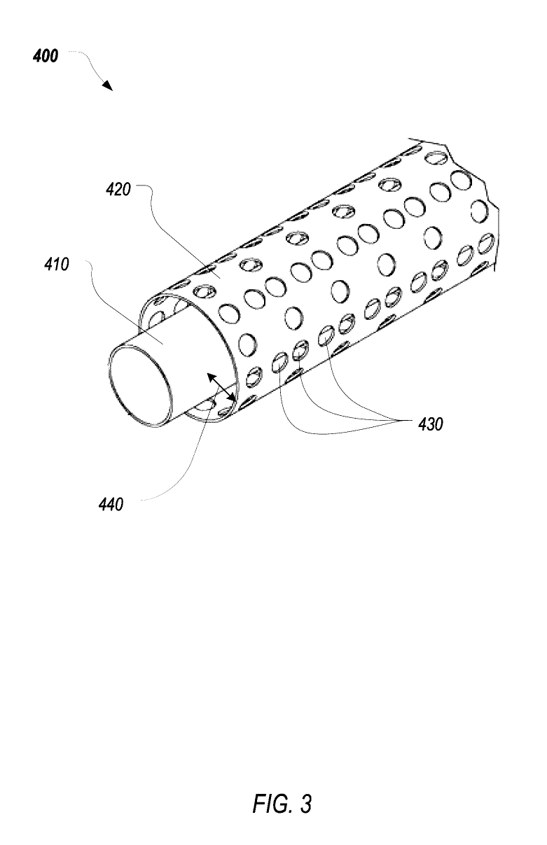

FIG. 3 illustrates a perspective view of some embodiments of an example electrode assembly 400. The inner electrode 410, the outer electrode 420, plurality of apertures 430 and the spacing 440 are shown.

In some embodiments, the spacing 440 can range from about 0.05 mm to about 15 mm. In other embodiments, the spacing 440 can range from about 0.1 mm to about 12 mm. In alternate embodiments, the spacing 440 can range from about 0.1 mm to about 10 mm. In yet other embodiments, the spacing 440 can range from about 1 mm to about 5 mm.

In other embodiments, the inner electrode 410 and the outer electrode 420 can be configured with a nested cylinder arrangement, with the inner electrode 410 configured as a cylinder that is centrally positioned within the outer electrode 420, the outer electrode 420 also configured as a cylinder. In some embodiments, the inner electrode 410 can be configured as a rectangular solid with a cross-sectional shape of a square and with the outer electrode 420 similarly configured. In other embodiments, the inner electrode 410 and the outer electrode 420 can be configured as a solid shape with a trapezoidal cross-section. In yet another embodiment, the inner electrode 410 can be configured as a plurality of electrodes that are sheathed by the outer electrode 420. In some embodiments, the inner electrode 410 may not be centrally positioned within the outer electrode 420. In other embodiments, the inner electrode 410 can be configured as an elongated flat sheet. In another embodiment, the inner electrode 410 can be configured as a curved sheet. In other embodiments, the inner electrode 410 can be configured as a cylinder with an ellipsoid cross-section.

In some embodiments the inner electrode 410 can configured as an anode and the outer electrode 420 can be configured as a cathode. In another embodiment, the inner electrode 410 can be configured as a cathode and the outer electrode 420 can be configured as an anode.

In some embodiments, the apertures 430 comprise circular cutouts in the outer electrode 420. In other embodiments, the apertures 430 comprise cutouts of other shapes. In other embodiments, the apertures 430 are configured in size and density to avoid dead zones and allow for release of gas at certain voltages, amperages, and currents. In another embodiment, the apertures 430 may be configured as a mesh, screen, or braided arrangement. In yet other embodiments, the outer electrode 420 and the apertures 430 can be configured as a welded wire mesh, a woven wire mesh, a coated wired mesh, a cage mesh, a wire cloth mesh, and/or a hexagonal netting mesh. In alternate embodiments, the outer electrode 420 and the apertures 430 can be configured as expanded metal, flattened expanded metal, hexagonal expanded metal, square expanded metal, micro expanded metal, and/or ribbon mesh expanded metal.

In some embodiments, the electrode assembly 400 can be configured to be housed within a flow cell that can be configured to allow the wastewater and/or suspension of microalgae in growth media to contact and flow through the electrode assembly 400. In other embodiments, the flow cell can then be incorporated into any of the embodiments of this application. In yet other embodiments, the electrode assembly 400 can be configured to be directly in contact with the wastewater and/or suspension of microalgae in growth media. In some embodiments, the electrode assembly 400 can be assembled as an array and configured as part of a flow cell or configured to be directly in contact with the wastewater and/or suspension of microalgae in growth media.

In some embodiments, both the inner electrode 410 and the outer electrode 420 can be configured with a nested cylinder arrangement. The inner electrode 410 can be configured as an anode and can comprise a non-donating conductive material. This non-donating conductive material can comprise a noble metal such as platinum, ruthenium, rhodium, palladium, osmium, iridium, or combinations thereof. The outer electrode 420 can be configured as a cathode and can comprise stainless steel or similar material. The apertures 430 can comprise a pattern of round holes in the outer electrode 420. The spacing 440 may range from about 1 mm to about 9 mm.

In some embodiments, any of the electrodes of the electrode assemblies 300, 400 may comprise metal, composite, or other material known to impart conductivity, such as, but not limited to silver, copper, gold, zinc, nickel, brass, bronze, lead, platinum group metals, steel, stainless steel, carbon allotropes, and/or combinations thereof. Non-limiting examples of conductive carbon allotropes can include graphite, graphene, synthetic graphite, carbon fiber (iron reinforced), nano-carbon structures, and other forms of deposited carbon on silicon substrates.

In some embodiments, the electrodes can be comprised of a catalyst-coated metal such as iridium oxide coated titanium. Such metals can enhance the efficiency of certain processes. For example, by using iridium oxide coated titanium on the anode, the creation of gas bubbles can be facilitated.

In some embodiments, any of the electrodes of the electrode assemblies 100, 300, 400 may comprise a solid support substrate core coated with a non-donating material. In other embodiments, any of the electrodes may comprise a hollow support substrate core coated with a non-donating material. In some embodiments, the electrode configured as an anode can comprise an anode material. In other embodiments, the electrode configured as a cathode can comprise a cathode material.

In some embodiments, the anode material can comprise carbon, copper, and platinum group metals. In other embodiments the cathode material can comprise carbon, copper, and platinum group metals.

In some embodiments, any of the electrodes of the electrode assemblies 300, 400 may comprise a mixed metal oxide (MMO). MMOs are compounds composed of oxygen atoms bound to transition metals. MMOs have a wide variety of surface structures which affect the surface energy of these compounds and influence their chemical properties. The relative acidity and basicity of the atoms present on the surface of metal oxides can also be affected by the coordination of the metal cation and oxygen anion, which alter the catalytic properties of these compounds. In some embodiments, the blend of MMOs can be a blend of the six platinum group metals layered onto a titanium core. These metals include ruthenium, rhodium, palladium, osmium, iridium, and platinum. A particular blend of metals can be created for a desired result. For example a weighted blend of ruthenium will generate a plurality of protons whereas weighing the blend towards iridium will generate a plurality of hydroxyls.

In some embodiments, the anode material can comprise a non-donating conductive material such as a noble metal including platinum, ruthenium, rhodium, palladium, osmium, iridium, or combinations thereof. In other embodiments, the anode material may comprise materials such as titanium. In alternate embodiments, the anode material may comprise carbon or conductive plastics such as polyethyne. In some embodiments, the anode material may comprise a ceramic coated with and/or embedded with a non-donating conductive material.

In some embodiments, the cathode material can comprise a non-donating conductive material such as a noble metal, including platinum, ruthenium, rhodium, palladium, osmium, iridium, or combinations thereof. In other embodiments, the cathode material can comprise stainless steel. In another embodiment, the cathode material can comprise carbon or a conductive plastic such as polyethyne. In some embodiments, the cathode material may comprise a ceramic coated with and/or embedded with a non-donating conductive material.

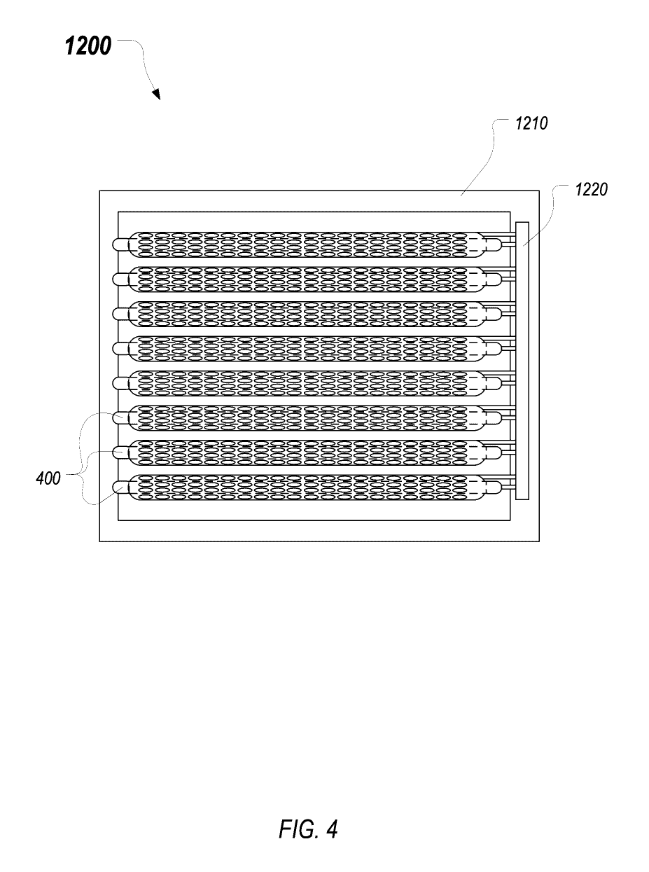

FIG. 4 illustrates an example electrode array 1200 comprising a nonconductive frame 1210 configured to secure a plurality of electrode assemblies 400. The electrode array 1200 further comprises a connector system 1220 configured to connect the inner electrode connectors 415 and the outer electrode connectors 425 of the plurality of electrode assemblies 400. The connector system 1220 is configured to electrically connect the plurality of electrode assemblies 400 in parallel. In some embodiments, the nonconductive frame 1210 is configured to secure the plurality of electrode assemblies 400 in a planar configuration. In other embodiments, the nonconductive frame 1210 is configured to secure the plurality of electrode assemblies 400 in other configurations that minimize dead zones and maximize release of gas. In alternate embodiments, the nonconductive frame 1210 can comprise other suitable nonconductive materials such as plastic, epoxy, fiberglass, glass, ceramics and rubber. In another embodiment, the connector system 1220 is configured to electrically connect the plurality of electrode assemblies 400 in series. In yet another embodiment, the electrode array 1200 is configured such that individual electrode assemblies 400 can be easily removed and replaced within the electrode array 1200.

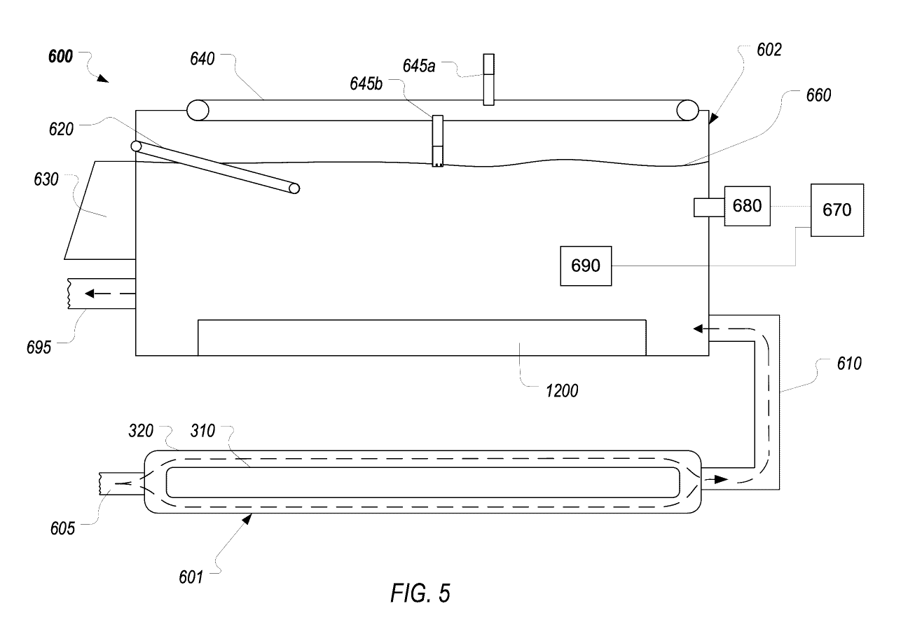

FIG. 5 and FIG. 9 illustrate embodiments of a system utilizing reduction or oxidation reactions to reduce total organic compounds in wastewater or to harvest/dewater microalgae from growth media. An example configuration of an apparatus 600, 905-906, or 905-914 that treats wastewater and/or harvests/dewaters algae from growth media. Apparatus 600, 905-906, or 905-914 includes two primary components: a reactor tube 300 configured as a first stage flocculation tank 601, 905, and a second stage flotation tank 602, 906, 914.

The wastewater and/or suspension of microalgae in growth media can be inputted into first stage flocculation tank 601, 905 through influent port 605. The wastewater and/or suspension of microalgae in growth media can be treated within the first stage flocculation tank 601, 905 to begin homogenizing and to generate bubbles within first stage flocculation tank 601, 905. This process can be initiated by applying a voltage differential to the electrodes as will be further described below. Once homogenizing and bubble generation has started, the suspension of wastewater byproducts and/or microalgae in growth media can be fed into second stage flotation tank 602, 906, 914 by flow path 610.

Once the wastewater and/or suspension of microalgae in growth media reaches the second stage flotation tank 602, 906, 914, the pH can be modified by the addition of a base solution through injector 680. In some embodiments, the base solution can comprise a strong base. In other embodiments, the base solution can comprise one or more of ammonia, calcium hydroxide, magnesium hydroxide, lithium hydroxide, e-methlamine, ethylamine, potassium hydroxide, sodium hydroxide, aniline, or other suitable base. In yet other embodiments, the base can comprise one or more of dibasic potassium phosphate, tribasic potassium phosphate, dibasic sodium phosphate, tribasic sodium phosphate, or other suitable base containing phosphate. The base solution can be added to increase the pH to above about 7.0, 8.0, 9.0, and/or 10.5. In some embodiments, a pH sensor 690 can be disposed within the tank 602 and configured to measure the pH. The pH sensor 690 can be configured to relay pH information to a controller 670. The controller 670 can be configured to control injector 680 according to the pH information received from pH sensor 690. If the pH is below a set point such as pH 10.5, the controller 670 can activate the injector 680 to inject base solution to raise the pH to the set point. If the pH is at the set point (or within a range close to the set point), the controller 670 can deactivate the injector 680. In some embodiments, increasing the pH of the suspension of microalgae in growth media causes the wastewater byproducts and/or microalgae to flocculate and/or aggregate. The flocculated wastewater byproducts and/or microalgae can then be removed from the processed wastewater and/or growth media.

The second stage flotation tank 906, 602 can produces gas (e.g. hydrogen and oxygen) bubbles which rise through the flocculated wastewater and/or microalgae and growth media. As the gas bubbles rise, the gas bubbles entrain the flocculated wastewater byproducts and/or microalgae to the surface 660. This process can result in a mat of flocculated wastewater byproducts and/or algae forming at the surface 660. Finally, the flocculated microalgae and/or wastewater byproducts can be removed using conveyors 620 and 640 as will be further described below. The substantially clarified growth media and/or treated wastewater can then be recovered from effluent valve 695 to be reused or discarded.

As shown in FIG. 5 and FIG. 9, in some embodiments, the flocculation tank 601, 905 can be configured with the electrode assembly 300 and can include an outer electrode 320 configured as a cathode formed by an outer cylinder (e.g. an enclosed pipe or tube), and an inner electrode 310 configured as an anode formed by an inner cylinder (e.g. a pipe or other enclosed cylindrical shape) that is contained within the outer cylinder. Accordingly, the suspension of wastewater and/or microalgae in growth media can flow between the outer electrode 320 and the inner electrode 310 as shown by the dashed arrows in FIG. 5. A voltage differential can be applied across to each of outer electrode 320 and inner electrode 310 to cause an electric current to pass through the suspension of wastewater and/or microalgae in growth media. In other embodiments, the flocculation tank 601, 905 can be configured with electrode assembly 400 configured in a flow-through configuration.

Regardless of the mode used to remove flocculated wastewater byproducts and/or harvest/dewater microalgae, flocculation tank 601, 905 can be configured with controls for automatically determining the appropriate settings to ensure that microalgae are sufficiently processed before exiting flocculation tank 601, 905. For example, in a batch mode configuration, flocculation tank 601, 905 can automatically determine an appropriate duration of time to treat the suspension of microalgae in growth media or appropriate voltage levels to apply across inner electrode 310 and outer electrode 320. Similarly, in a continuous flow mode configuration, flocculation tank 601 can automatically determine an appropriate flow rate and appropriate voltage levels to apply across inner electrode 310 and outer electrode 320.

Once the suspension of wastewater and/or microalgae in growth media has been processed, it can be transferred via flowpath 610 to flotation tank 602, 906, or 914. An electrical field can be applied to the suspension within flotation tank 602, 906, or 914 using electrode array 1200. The electric field can increase interface potential between solvent and solute and create micron-sized bubbles of hydrogen and oxygen gas which lift the flocculated wastewater byproducts and/or microalgae to the surface 660. The flocculated contaminants can form a mat at the surface 660 allowing for easy removal of the flocculated wastewater byproducts and/or microalgae.

Flotation tank 602, 906, or 914 can also include conveyor 620 and conveyor 640 (having rakes 645a and 645b) and which can be configured to remove flocculated microalgae from flotation tank 602, 906, 914 and into collector 630 as will be further described below. Other means for removing the flocculated microalgae from the surface 660 of the media can also be used as known in the art.

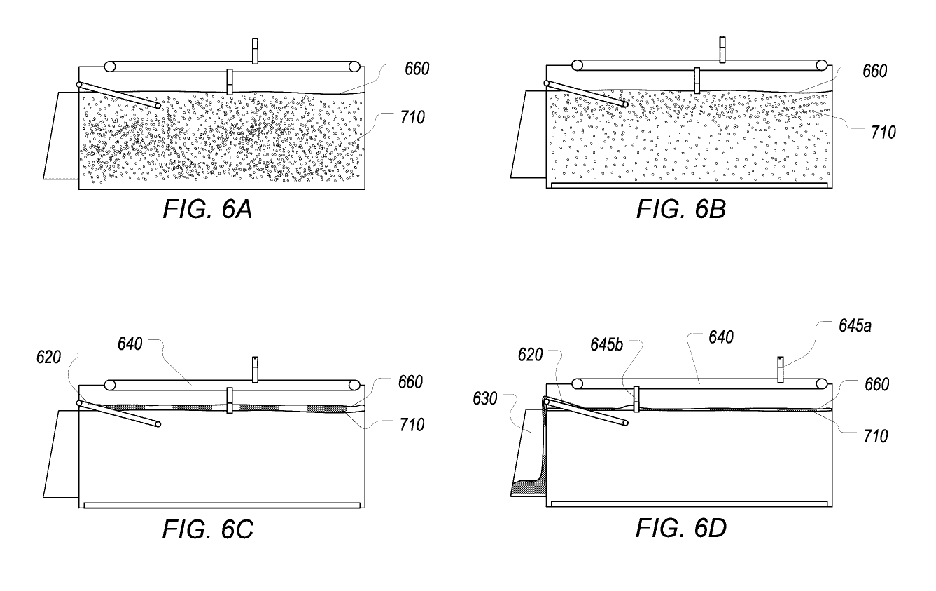

FIGS. 6A through 6D illustrate some embodiments of flotation tank and/or oxidation chamber 602, 906, or 912 to provide an example of how the flocculated algae and/or wastewater byproducts 710 can be floated to the surface 660 and removed. FIG. 6A illustrates the state of flotation/oxidation chamber tank 602, 906, and/or 912 when the suspension of wastewater byproducts and/or microalgae in growth media is passed into flotation/oxidation tank 602, 906, or 914. At first, the flocculated microalgae 710 can be dispersed throughout the tank 602, 906, or 914. Next, FIG. 6B shows that as gases are generated by the electrodes, the gases rise through the growth media and entrain the flocculated wastewater byproducts and/or microalgae 710 to the surface 660.

FIG. 6C shows the state of flotation tank/oxidation chamber 602, 906, or 914 after the flocculated wastewater byproducts and/or microalgae 710 have floated to the surface 660. FIG. 6C also illustrates that the remaining growth media underneath the floating clumps is substantially clear. Finally, FIG. 6D illustrates an example of how the flocculated wastewater byproducts and/or microalgae 710 can be removed. As shown, this removal can be performed using rakes 645a, 645b which are rotated over the surface 660 to rake the wastewater byproducts and/or flocculated microalgae 710 towards conveyor 620. Conveyor 620 is rotated to transfer the flocculated wastewater byproducts and/or microalgae 710 into collector 630 where it can be retrieved for further processing or use.

FIGS. 6A through 6D generally represent the process as being performed in batches (i.e. the batch of suspension is fully flocculated before any suspension is added). However, in some embodiments, this process can be performed on a continuous basis such as by periodically adding the suspension of microalgae, acid, base, pH modifiers and/or coagulants in growth media.

Gas bubble formation can be facilitated by strategically placing the electrodes in proximity to one another. For example, in some embodiments, the cathode(s) and anode(s) are spaced between about 0.1 inches and about 36 inches apart, between about 0.2 inches and about 24 inches apart, about 0.5 inches and about 12 inches apart, about 0.5 inches and about 6 inches apart, about 3 to about 8 inches apart, about 1 inch to about 3 inches apart, or variations and combinations of these ranges or values within these ranges. The ratio of separation may vary depending on the conductivity of the growth media and/or the power levels applied to the electrodes. For example, the more saline or conductive the growth media, the smaller the gap that may be required for hydrogen and/or oxygen production. In some configurations, the placement of two or more cathodes near a single anode can increase turbulence about the anode, creating a heightened mixing effect that can assist in aggregating and lifting the flocculated microalgae 710.

In some embodiments, the system 600 can comprise more than one flotation tank 602, 906, or 914. For example three oxidation/flotation tanks 602, 906, or 914 can be connected in series with influent entering a first tank to be treated and then flowing to a second tank to receive further treatment and then flowing to a third tank to receive a third treatment. The first tank can be configured with an acid injector configured to dispense acid solution to reduce the pH of the growth media. The first tank can also be configured with a first tank pH sensor to monitor a pH of the growth media in the first tank. The controller 670 can be configured to communicate with and to control the acid injector and the first tank pH sensor. For example, if the first tank pH sensor indicates that the first tank pH is above a set point, the controller 670 can activate the acid injector to inject acid solution to reduce the pH. As the first tank pH approaches the set point, the controller 670 can communicate with the acid injector to cease addition of acid solution. The second tank can be configured in the same fashion, but with a base injector configured to inject base solution to raise the pH. The controller can use data from a second tank pH sensor to maintain the second tank pH at a set point. Likewise, the third tank can be configured in like fashion, but with controller 670 maintaining a neutral pH in the third tank.

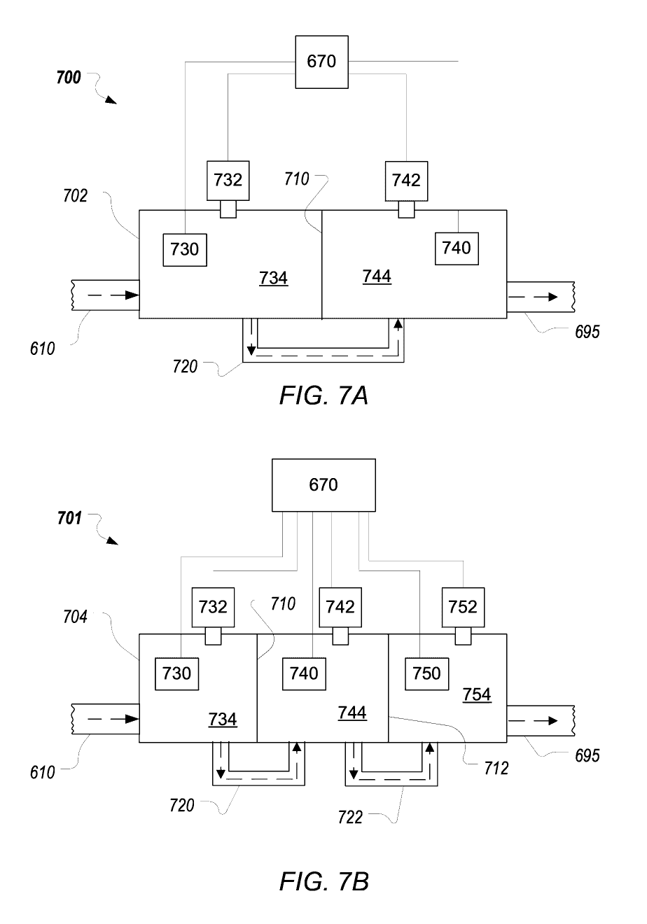

FIG. 7A illustrates some embodiments of a system 700 for purifying wastewater by removing contaminants from wastewater, dewatering and/or harvesting microalgae from growth media. In some embodiments, system 700 can configured in a similar fashion as system 600 with the suspension of wastewater and/or microalgae in growth media configured to flow through flocculation tank 601 and/or oxidizer array 905 and then enter a flotation tank 702 through flowpath 610. After treatment in flotation tank 702, treated wastewater and/or growth media can flow from flotation tank 702 through flowpath 695 to be returned to a growth tank. System 700 can also comprise electrode array 1200 and conveyors 620, 640, collector 630, and other components configured to entrain flocculated microalgae to the surface 660 and to harvest the microalgae from the surface 660.

In some embodiments, flotation tank 702 and or oxidation chamber 914 can comprise a barrier 710 configured to divide flotation tank 702 into a first chamber 734 and a second chamber 744. The system 700 can further comprise a flow path 720 configured to transport growth media from the first chamber 734 to the second chamber 744, through various processes as illustrated in FIG. 9. The flow path 720 can further comprise valves, pumps, and/or flow control devices configured to be controlled by the controller 670 to permit and/or restrict flow between the first chamber 734 and the second chamber 744. The system 700 can further comprise a pH sensor 730 disposed within the first chamber 734 and configured to monitor the pH of the first chamber 734 and relay the pH to the controller 670. The system 700 can further comprise an injector 732 for introducing chemicals, aqueous solutions, organic solutions acid, or bases, as detailed below in relation to FIG. 9, and may be configured to be controlled by controller 670, and configured to inject either acid solution or base solution into the first chamber 734 to maintain a set pH. The system 700 can further comprise a pH sensor 740 disposed within the second chamber 744 and configured to monitor the pH of the second chamber 744 and relay the pH to the controller 670. The system 700 can further comprise an acid/base injector 742 configured to be controlled by controller 670 and configured to inject either acid solution or base solution into the second chamber 744 to maintain a set pH.

In some embodiments, a user can set the pH for the first chamber 734 and for the second chamber 744 with the controller 670. The controller then monitors the pH in each of the first chamber 734 and the second chamber 744 and injects either acid solution or base solution with the injectors 732, 734 to maintain the individual set pH for each chamber. For example, the system 700 can be configured such that the set pH of the first chamber 734 is 10.5 to allow for flocculation and recovery of the microalgae. Then the pH of the second chamber 744 can be set at a neutral pH. Once some or all of the wastewater byproducts and/or microalgae is removed from the growth media in the first chamber 734, the remaining media can be transferred to the second chamber 744 through flow path 720, and/or through various processes as illustrated in FIG. 9, for example. The pH of the growth media in the second chamber 744 can then be adjusted to a neutral pH to prepare it for return to the growth tank or for discharge. Other configuration are also possible including having the first chamber 734 set to an acidic pH and the second chamber 744 set to a basic pH. The first chamber 734 can also be set to an acidic pH and the second chamber 744 set to a neutral pH. In other embodiments, the pH of the first chamber 734 and the second chamber 744 can be set to any appropriate pH to facilitate purifying wastewater, removing organic compounds from wastewater, and/or dewatering of the microalgae and processing of the growth media. In some embodiments, system 700 can comprise additional sensor and/or monitors to monitor and/or regulate characteristics of the wastewater, microalgae and/or growth media. System 700 can comprise one or more of temperature sensors, dissolved oxygen sensors, conductivity sensors, salinity sensors, turbidity sensors, and other suitable sensors. The sensors can communicate with controller 670.

FIG. 7B illustrates some embodiments of a system 701 for utilizing reduction or oxidation reactions to reduce total organic compounds in wastewater and/or dewatering/harvesting microalgae from growth media. In some embodiments, system 701 can configured in a similar fashion as system 700, with the exception that system 701 comprises a tank 704 comprising a second barrier 712. Together barrier 710 and barrier 712 divide tank 704 into a first chamber 734, a second chamber 744, and a third chamber 754. The system 701 can further comprise a flow path 722 configured to transport growth media from the second chamber 744 to the third chamber 754. The flow path 722 can further comprise valves, pumps, and/or flow control devices configured to be controlled by the controller 670 to permit and/or restrict flow between the second chamber 744 and the third chamber 754. The system 701 can further comprise a third pH sensor 750 disposed within the third chamber 754 and configured to monitor the pH of the third chamber 754 and relay the pH to the controller 670. The system 701 can further comprise an acid/base injector 752 configured to be controlled by controller 670 and configured to inject either acid solution or base solution into the third chamber 754 to maintain a set pH.

System 701 can function in similar fashion as system 700 with the added benefit of the third chamber 754 that can be set to a third pH set point. In some embodiments, each of the first chamber 734, second chamber 744, and third chamber 754 can be set to distinct pH set points to facilitate the purifying wastewater, removing organic solids from wastewater, flocculation and removal of microalgae, and the processing of the growth media. For example, the first chamber 734 can be set to an acid pH, the second chamber 744 can be set to a basic pH, and the third chamber 754 can be set to a neutral pH. In this configuration, the wastewater and/or microalgae can be flocculated and removed in the first chamber 734 and the second chamber 744 and the growth media can be conditioned for additional treatment and/or return in the third chamber 754. In other embodiments, the first chamber 734 can be set to a basic pH, the second chamber 744 can be set to an acidic pH, and the third chamber 754 can be set to a neutral pH. In some embodiments, the first chamber 734, the second chamber 744 and the third chamber 754 can each be set to a distinct acidic pH. In other embodiments, the first chamber 734, the second chamber 744 and the third chamber 754 can each be set to a distinct basic pH. In other embodiments, other pH set points and other flow paths can be configured to purifying wastewater and/or harvest microalgae from growth media.

In some embodiments, system 701 can further comprise additional chambers that can be set to distinct pH set points to facilitate purifying wastewater, removing organic solids from wastewater, flocculation and removal of microalgae, and the processing of the growth media. In some embodiments, multiple chambers may be set to a distinct acidic pH, a distinct basic pH and/or a neutral pH. In some embodiments, multiple chambers may be set to distinct pH set points to gradually adjust the pH of the wastewater and/or microalgae in growth media. In some embodiments, multiple chambers may be set to alternating pH set points to facilitate purifying wastewater, removing organic solids from wastewater, flocculation and removal of microalgae, and the processing of the growth media.

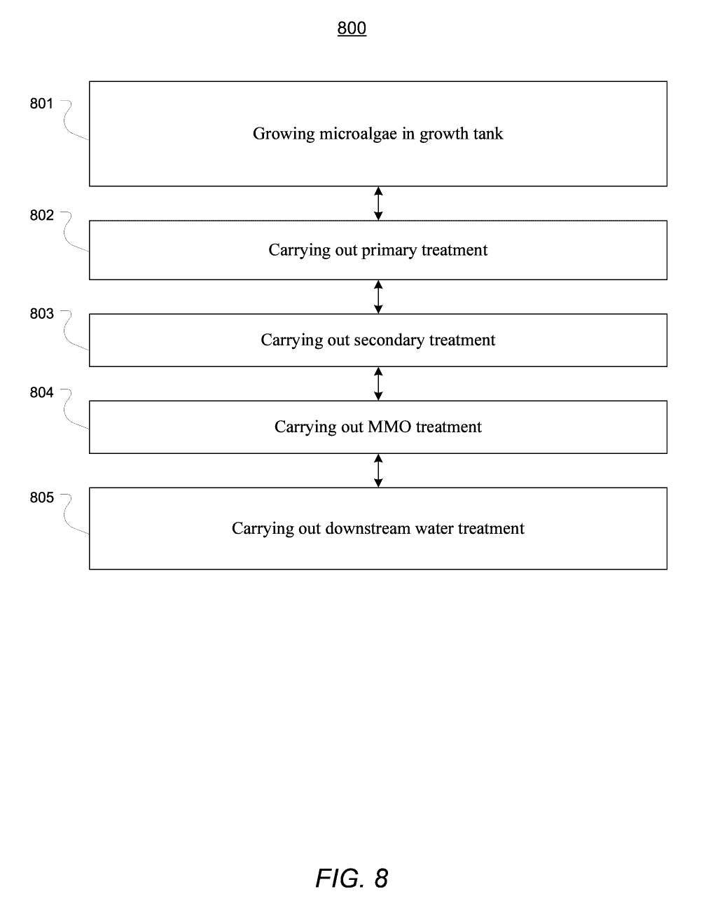

Referring to FIG. 8, in some embodiments, the systems and methods for dewatering and/or harvesting microalgae can comprise a method 800. First, box 801 refers to growing microalgae in a growth tank. In some embodiments, box 801 can include growing microalgae to density in a tank, race-way, and/or bioreactor. Box 802 refers to carrying out primary treatments. In some embodiments, Box 802 can refer to flowing microalgae through reactor tubes for initial contact with electrified MMO electrodes as a conditioning step and to generate microbubbles that infuse the suspension of microalgae and growth media. Box 803 refers to carrying out secondary treatment. In some embodiments, Box 803 can include entraining the microalgae by gravity or pump to a harvest zone, and injecting the suspension with pH modifiers to reach a pH of 11 or above to create auto-flocculation that is catalyzed by the MMO electrode assembly powered by direct current voltage. Box 804 refers to carrying out MMO treatment. In some embodiments, Box 804 can include treating with MMO electrodes to generate microbubbles to entrain flocculated microalgae to the surface of the suspension, provide for extreme aerobic conditions for long shelf life, and/or to mechanically harvest the flocculated microalgae with a mechanical conveyance such as a rake to weir or rake to belt. Box 805 refers to carrying out downstream water treatment. In some embodiments, Box 805 can include conditioning the growth media with carbon dioxide or other beneficial weak acid for return to the grow tank.

FIG. 9 is a schematic of the two stage system to lower remove organics entrained in wastewater prior to oxidation. The influent wastewater may be pretreated to remove large particulates 901. For example, this stage 901 can include screw press, clarifiers, settling tanks, and sand filtration. Then the grossly filtered product is allowed to flow or pumped through a mixing tank 902 where coagulants and pH modifiers 903 are brought into contact with the water. The mixed product may be entrained by pump through a static mixer 904 through to a set of MMO based anode and cathode reactors 905, 300 and/or 400. The mixed product is then entrained to the organics removal flotation tank 600 and/or 906 which includes a plurality of anodes 912 where the product is dewatered with sludge being removed as described above in relation to FIGS. 5 and 6 and moved to an anaerobic digester 908 and the effluent 909 may then be filtered through a combination of media filters 911 and or ultra-filtration 910 upon filtration, the product is held in storage or buffer tank 902a, upon which it the entrained through a pump to a static mixer 904 which micron mixes a strong acid such as HCL 913 and further processed by a set of oxidizing arrays 905 and disgorged into a oxidation chamber 914 through a set of electrocatalytic multiple metal oxide anodes 912, the products of which sludge 907 is returned to an anaerobic digester 908 and the effluent 909a may be fed to a sequence of media 910a and ultra-filtration 910 processors to final polish the liquid effluent, for example by reverse osmosis 915 to meet discharge quality 916.

To minimize the disinfection byproducts (DBPs) formation from the organic matters of landfill leachate in treated wastewater effluent, certain strategies may be utilized. In one embodiment, initially removing DBP precursors, for example the humic-like landfill leachate organic compounds, prior to chlorination in wastewater treatment plants. Due to their biologically recalcitrant properties, the organic matter may be removed by physicochemical processes, according to some embodiments described herein. Several treatment methods, including hydroxyl radical (OH·)-based advanced oxidation processes, electrochemical oxidation, and membrane processes, may be utilized in association with the embodiments described herein to facilitate high flow-through wastewater treatment capacities. Electrochemical oxidation as described herein may be utilized to completely oxidize organic compounds detectable through standard COD testing, as well as ammonia nitrogen. Pressure-driven membrane processes, nano-filtration (NF) and reverse osmosis (RO), may be utilized in association with the wastewater treatment methods described herein, and in combination with various embodiments of the claimed invention are able to remove almost all the organic and inorganic impurities in landfill leachate including organic matters. But application of nano-filtration and reverse osmosis alone are limited by high capital and operation costs because of high energy consumption and membrane replacement due to membrane fouling. Additional, methods may be used in association with the system and methods described herein for treating wastewater, for example, sulfate radical (SO₄² ·)— based advanced oxidation processes may be used in association with the described embodiments to remove organic matter detectable through standard COD testing and ammonia. In additional embodiments, additional treatment of wastewater effluent to remove DBPs subsequent to disinfection may be utilized to remove DBPs produced, prior to final discharge of effluent treated wastewater.

In some embodiments, systems and methods described herein may be used to decrease and/or remove natural organic matter (NOM) and biorefractory aqueous pollutants in waste streams which are dewatered through a reduction mechanism enhanced by catalytic reactions generated by multiple metal oxides utilized as reactors and bubble generators. This primary step may be carried out at pH at or above 7 to mitigate the generation of active HOCL compounds which could react and create DPBs.

The steepest portion of the curve is between pH 7 and 8. Even a 0.1 unit change in pH can cause a significant change in the ratio between HOCl and OCl⁻. This is significant because HOCl is a stronger disinfectant than OCl⁻. Accordingly DBP production during the chlorination process is pH dependent.

FIG. 9 represents a schematic of systems and methods for purifying wastewater and/or removing organic matter from wastewater, prior to disinfection without production of DBPs. In FIG. 9, in the first step of the process, a base such as NaOH, lime, soda ash or other base metal salt is titrated to the incoming tank 902 until the pH is at 7 or above. In the case of a higher pH product that needs to be brought down to the range of pH 7-8, the reduction chemical used could be a weak acid such as acetic or formic. According to some embodiments, the second step 903 is the introduction of a coagulating agent. With aluminum sulfate, optimum coagulation efficiency and minimum floc solubility normally occur at pH 6.0 to 7.0. However, Iron coagulants can be used successfully over the much broader pH range of 5.0 to 7.5. Thus the use of Ferric compounds such as Fe sulfate or potassium is preferred, giving rise to the following chemical formula: Fe₂(SO₄)³+6NaHCO₃=2Fe (OH)₃⁻+3Na₂SO₄+6CO₂. A number of coagulating agents can be used such as Chitosan or the cationic polyelectrolytes polyamines and poly-(DADMACS) commonly used as primary coagulants at higher pH values. An example of commercially available coagulation agents are Kemira® Ferric Sulfates (KEMIRA PIX) are effective primary coagulants based on trivalent iron (Fe³⁺), and are excellent for drinking water production, wastewater treatment, phosphorus removal applications, struvite control as well as sludge conditioning. The products are also efficient in preventing odor and corrosion by controlling the formation of hydrogen sulfide. Kemira® Dry Ferric Sulfate (KEMIRA FERIX) is a high purity granulated ferric sulfate product. The iron content is 19-21% as ferric iron. The product is soluble in water to a concentration of approx. 10% Fe-solution (approx. 36% Fe₂(SO₄)³). It is an effective primary coagulant that performs superbly in both drinking water and wastewater treatment applications over a wide pH-range. The use of chemical flocculants is based on system efficiency, application and cost. Commonly used chemicals include trivalent metallic salts of iron, such as FeCl₂ or FeSO₄ or aluminum, such as AlSO₄. Organic and inorganic polymers (cationic or anionic) can be used in this phase. Testing may be utilized to dictate formulation and dosage of admixtures. The most commonly used inorganic polymers are the polyacrylamides. Chemical flocculant concentrations used normally range from 100 to 500 mg/l (One mg/l in 1 million gallons per day is 8.34 lbs. of material). The wastewater pH may need to be adjusted between 7.0 and 7.5 for the ferric compounds or between 6.0 and 7.0 for the aluminum compounds using an acid such as H₂SO₄ or C₂H₄O₂, CH₂O₂, or a base such as NaOH.

As depicted in FIG. 9, the coagulation/flocculation and sedimentation process may be subjected to three distinct unit processes: high shear, rapid mix for coagulation 904; low shear, high retention time, moderate mixing for flocculation 906; and liquid and solids separation 907. In some embodiments, during the introductory stage to flocculation, a static mixer 904 is utilized to rapidly and at high shear introduce the coagulating agent. The static mixer is primarily a constricted tube that includes a venturi introductory valve. There are many such mixers for example: OHR®, Kennics®, Statisflow® and Mazzei®. Furthermore, certain pumps such as the Nikuni Regenerative pump may be used to both entrain and introduce coagulating agents. In some embodiments, during the next step, the fluids are brought into contact through a reactor tube(s) 905, 300 and/or 400. These reactor tubes may comprise a multiple metal oxide clad anode sheathed, within a cathode to electro-mechanically bring into contact the material and generate Reactive Oxygen Species (ROS) chemically reactive molecules containing oxygen. Examples of ROS include peroxides, superoxide, hydroxyl radical, and singlet oxygen. These compounds have shown to dramatically decrease the removal of refractory organic compounds. In some embodiments, sulfate compounds (Fe and Al) may be used for reduction of organic matter in waste streams, as well as other common reducing agents such as weak acids (e.g., Oxalic, Formic and Ascorbic acid) compounds can be used if deemed practical and do not generate DPBs.

As illustrated in FIG. 9, the product is then entrained into a flotation tank 906, or as shown in prior figures as 600, under a rack of dynamically stable anodes enrobed in a mesh cathode composed of Titanium 912 or as shown in FIG. 4 as 1200, and electrified so as to produce electrolytic bubbles and ROS. The composition of the anode can consists of variation on noble metals which can be single metal or binary metals. Some supported metal oxides which are widely employed include single metal oxides of PbO₂, RuO₂, IrO₂, Al₂O₃, TiO₂ nanotubes (TiO₂-NTs), and binary MMOs of Ir—Ru—O, Ir—Ta—O and Sn—Sb—O. For the application of removing or alleviating organic compounds in wastewater, some of the important MMO anodes based on the bulk mixed metal oxide system include Sn—Sb binary MMO anodes, Ir—Ru binary MMO anodes, Ir—Ta binary MMO anodes, Ti—Ru binary MMO anodes, Ti—Bi binary MMO anodes, Ir—Ru—Sn ternary MMO anodes, Ce—Ru—Sn ternary MMO anodes and Ru—Ir—Sn—Ti quaternary MMO anodes.

The design of the flotation tank 600, 900 is such as to introduce the product from the reactor tubes 300, 400, 905 under the MMO arrays 912, 1200 through a diffuser plate so as to not generate turbulence. In preferred embodiments, the flotation zone 906 preferably has a minimum retention time of 20 minutes to maximize the production of ROS and flocculate the product properly to the surface of the tank for removal by known methods such as rake or brushes. The sludge 907 is swept off the top of the tank through a conveyance system for removal and disposal to an anaerobic digester 908 for further processing. It is estimated that the amount of sludge is roughly 10-15% of the total flow. In some embodiments, as illustrated in FIG. 9, the effluent 909 may then be flowed through a system of bag filters 911 and Ultra Filtration 910 for polish and removal of any particulates over 0.5μ. The clarified product may then be flowed to a holding tank 902a for the second part of the process.

As illustrated in FIG. 9, during the oxidation step, the process described above is repeated almost identically with the major difference being the introduction of strong acids 913. In this sequence, strong acids such as HCl (hydrochloric), HNO₃ (nitric), H₂SO₄ (sulfuric), HBr (hydrobromic) HI (hydroiodic), HClO₄ (perchloric), or HCl may be utilized.

### Example 1

A test run was carried in which microalgae were harvested using pH modification and electrolysis. The test run was performed to food grade standards using a modified OriginClear harvester (OriginClear, Los Angeles, Calif.). In its unmodified form, the OriginClear harvester is configured to harvest micro-algae from growth medium using donating anodes in an electro-coagulation-flocculation system. For this study, the OriginClear harvester was modified to include an injection feature configured to raise the pH under the control of a programmable logic controller (PLC). The modified OriginClear harvester was configured to perform auto-flocculation with electrolytes to harvest microalgae as food grade products. The modified OriginClear harvester comprised a 40 gallon (150 liter) flotation tank.

The microalgae species, Nanno 3600 (strain CCMP525), was used for the study. Nanno 3600 is a high-yield rotifer feed that is a single species of the microalgae genus, Nannochloropsis, and produces phospholipid-rich rotifers. Nanno 3600 also provides a high feed conversion rate with minimal organic waste excreted to the growth tank. Nanno 3600 also give an EPA and ARA pre-enrichment boost for use with high-DHA enrichment protocols.

The Nanno 3600 was grown to a density of about 1.5 g/L in fresh water media. The modified OriginClear harvester was operated at a flow rate of 2 gallons/minute (2 GPM). The modified OriginClear harvester was configured with catalytic metals (Ir and Ru) in the coagulation tubes and in the flotation chambers. Both the coagulation tubes and flotation chambers were powered by DC current. A Hatch Hi9829 Multimeter was used to monitor the test run. Food grade solid sodium hydroxide (NaOH) was added as the electrolyte to increase the pH. Approximately 500 grams of solid sodium hydroxide was added to 25 gallons of water to generate a sodium hydroxide solution. The sodium hydroxide solution was injected under PLC control. The initial pH of the microalgae inflow was 8.43. The pH was raised to 10.5 as the microalgae inflow was entrained to the flotation tank.

The automated pH injector was configured to monitor pH at two different points in the system. The first point for pH monitoring was the incoming flow into the tank. The second point for pH monitoring was in the tank at a position approximately 4 inches from the bottom of the tank and above the flotation cathodes. The second point for pH monitoring provided a more accurate reading of the overall pH of the tank. The second point for pH monitoring was used by the PLC to govern pH injection as the pH set point. The pH set point was set to 10.5 and the PLC configured to inject sodium hydroxide solution as soon as flow began.

As the test run was initiated and flow began, the microalgae flocculated and were entrained to the surface of the media in the tank. The flocculated microalgae on the surface of the media were captured via a rake and belt system. Throughout the test run, the PLC injected sodium hydroxide solution as required to maintain an approximate pH of 10.5. The injection was based on the algorithm of approximately 1 mol/L of diluted sodium hydroxide.

During a test run, the PLC set points for the modified OriginClear harvester were set to:
SSE 1 (MMO) non donating anodes: 100%, 12 V, 10 A (this step generates microbubbles which assists in the flocculation)
SSE 2 donating anode: 0%: 0v 0 amps
HF: 75% 4.4 Volts 29 amps
Inflow pump: 2GPM

The test run was analyzed. The molar weight per kilogram was measured at about 575 mg/kg for the harvested biomass and for the return water. The influent and effluent were also analyzed. Table shows a comparison of the characteristics of the influent and effluent water.

TABLE 1

| | Influent | Effluent |
|---|---|---|
| pH | 8.43 | 10.39 |
| DO (dissolved oxygen) | 4.19 | 4.48 |
| μS/cm (conductivity) | 834 | 1318 |
| TDS (total dissolved solids) | 417 | 660 |
| PSU (salinity) | 0.41 | 0.66 |
| FNU (turbidity) | 461 | 37.1 |

As can be noted, good clarity was observed as turbidity was reduced from 461 FNU to 37.1 FNU. This corresponded to an approximate decrease of 94% or an approximate harvest ratio of 94%. The effluent water appeared light green in color compared to the dark green color of the influent. The pH of the effluent was 10.39. The effluent could be returned to the growth tank without further treatment. Alternately, the effluent could be transferred to an ancillary tank to be treated to lower pH prior to return to the growth tank. Treatment to lower pH could include treatment with carbon dioxide gas or acetic acid to lower pH. The dissolved oxygen (DO) content increased slightly indicating overall health of the returned growth media is maintained or ameliorated.

The harvested algae paste appeared clean upon visual inspection. The harvested algae paste also smelled fresh. The harvested algae paste was stored at room temperature for at least 7 days without any noticeable smell or bacteria degradation. Normally, a noticeable bad odor indicates bacterial contamination. However, other forms of contamination such as mold may not be detectable by odor. Additional testing can be carried out to determine bacterial contamination that may develop during continued storage.

In previous testing, other electrolytes such as calcium hydroxide and magnesium hydroxide were used. Both calcium hydroxide and magnesium hydroxide proved to be less effective than sodium hydroxide. When using calcium hydroxide, it appeared that contaminating carbonates affected flocculation. When using magnesium hydroxide, it appeared that the magnesium hydroxide did not dissociate properly to generate a floc because the magnesium hydroxide was not able to raise the pH above 9.5. However, these results may be specific to the Nanno 3600 species. For other microalgae species and growth densities, other electrolytes may function as well as or better than sodium hydroxide.

Sodium hydroxide as an electrolyte appeared to generate a rapid flocculation of the microalgae. Continued injection of sodium hydroxide appeared to be minimal once the pH reached about 10.5. The pH was maintained with occasional injections.

The TDS increased from an influent value of 417 mg/L to an influent value of 660 mg/L in one pass. It is possible that with several repeated passes that the TDS may rise above acceptable levels and that the return media may need to be diluted with fresh media or discarded. Because increased levels of sodium ion may also increase osmotic pressure and lead to microalgae crashes, dilution with fresh media or discarding of the return media may be required. Therefore, monitoring salt concentrations of may be routine to determine if return media should be discarded or diluted prior to return to the growth tank. However, one advantage of the Nanno 3600 species is that it is resistant to brackish conditions and may be able to tolerate higher levels of salt concentrations.

Furthermore, because the return water is oxidized and biomass removed, the bacteria/rotifer/ciliate population is substantially reduced. This reduction in bacteria/rotifer/ciliate population can be used as an advantage to restore overall growth tank health. Therefore, the method of the test run can be utilized to restore growth tank health as well as to harvest microalgae.

Some advantages of the current application include:

1) The system can be configured such that the microalgae are harvested and the return water is oxidized without damage to the microalgae cells.

2) The system can be configured such that potentially harmful or undesirable flocculating agents such as aluminum and iron are not needed. The aluminum and iron flocculating agents can be replaced with agents that are compatible with GRAS standards.

3) The system and methods yield valuable algae paste. While only at a 5% solid concentration, the harvested microalgae paste can be heat dried and processed to produce a bacteria-free product with a long shelf life which is a practical advantage. Although the dried microalgae paste does contain added sodium, the addition of sodium is likely well within GRAS standards and may well contribute to a long term shelf life.

4) The system and methods required dramatically less energy than conventional dewatering systems such as centrifugation.

### Example 2

Wastewater leachate, commonly known as black water, has come under new EPA standards. Several countries have implemented new rules for discharge and have funded the effort to modernize the methods and systems for handling this contaminant. The goal for this test was to reduce COD from 10,000 to 100 and Ammonia (NH₄) from the mid 3,000 ppm to below 8. Current technology (DTRO membrane) is considered by the user as not effective and costly due to the high rate of replacement cartridges. This test was conducted at a city dump which discharges 2000 tons/day, and has very few amenities, is remote and cold for 6 months of the year thus limiting the use of AD as a TOC reducing systems.

Technology Platform:
OriginClear® A25 modeled for algae and MMO flotation anodes for organics reduction
OriginClear® Model 12 algae equipped with MMO reactors and MMO flotation anodes for Oxidation
UF system
R/O system

Inflow water: While there is variation on the inflow, the mean is roughly
<10,000 ppm COD
<3500 ppm NH₄
pH of 8.35 to 8.7.
<TDS 11,000 ppm
Average temp: High 42F low: 34F

Metrics/Analytics:
Visual
COD, NH₄ testers
PH meters

Set Up: Sequences:
Sand filter
2000 liter holding tank
A25 organics separation stage 1
UF filtration
A12 Oxidation step Stage 2
UF clarity,
R/O polish.

Determining steps in the sequences was tried for 7 days.
Added FeSO₄.7H₂O Name: Iron(II) Sulfate Heptahydrate; Alias: Ferrous Sulfate Heptahydrate Molar Mass: 278.0146: Dose 100 mg/l therefore added 2 kg to 2 M/l
Further action was to add NaOH (6 g/l) to raise pH of holding tank to 9.0. Visual extreme flocculation and black product coming out of solution.
EF unit at 4.6 volts 59 amps. Step 1 Organic removal: Visual inspection of the floc: Floc and harvest: Flowed through UF to clarity
Flowed to A12 with pH of 8.7: injected HCl in solution to 6.5 Oxidation step
Product then flowed to UF again
Product flowed through R/O for polish

Discussion:

Lab results: Prior to RO:

| Metric (mg/l) | Input | After EWS | Percentage drop |
|---|---|---|---|
| COD | 10239 | 2583 | 75% |
| Ammonia | 2036 | 610 | 70% |
| Total Nitrogen | 2078 | 713 | 65% |

Cost of Materials: Per 1000 L (US)
1 Kg of FeSO₄ 0.40
½ Kg of Chlorite 0.10
NaOH 100 g 0.05
HCl 31 0.60
Energy: 2 kWh 0.20

Total cost of process: US 1.50+/−per M/l for 70% reduction in Total organic load. Compared to 12/metric ton with membranes.

Transit time: It is preferred that all processes from organic load separation to oxidation be allowed at least 30 minutes transit time. This factor alone would dictate a higher efficiency number.

Conclusion: This process shows promise in remediation of not just leachate, but any waters with a high contaminant load. The combination of MMO reactor tubes, or high shear and contact zones, and Electro-induced flotation shows great promise for lowering the load on polish systems such as membranes, or reverse osmosis systems. The dual system of organic removal prior to oxidation lowered the amount of DPBs in the process flow.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A system for purifying wastewater comprising:
a reactor tube, the reactor tube comprising an outer cathode and an inner anode, the inner anode being positioned centrally within the outer cathode such that a spacing exists between an outer surface of the inner anode and an inner surface of the outer cathode;
a pump connected to an input of the reactor tube, the pump receiving a wastewater influent and pumping the wastewater into and through the reactor tube such that the wastewater flows between the inner anodes and the outer cathodes and exits through an output;
a tank connected to the output of the reactor tube, the tank comprising a plurality of tank electrodes configured to generate gas bubbles;
a pH sensor disposed within the tank and configured to monitor a pH of the wastewater; and
an injector configured to inject a basic solution into the tank to increase the pH of the wastewater;
wherein a voltage differential applied across the outer cathode and the inner anode causes organic material in the wastewater to homogenize, wherein the increase in pH causes the organic material to flocculate, wherein the gas bubbles entrain the flocculated organic material to a surface of the tank.

2. The system of claim 1, wherein the spacing between the outer surface of the inner anode and the inner surface of the outer cathode is between about 1 mm to about 9 mm.

3. The system of claim 1, wherein the inner anode of the reactor tube comprises a non-donating conductive material selected from a list comprising platinum, ruthenium, rhodium, palladium, osmium, iridium, titanium, carbon, conductive plastic or combinations thereof.

4. The system of claim 1, wherein the outer cathode of the reactor tube comprises a non-donating conductive material comprises platinum, ruthenium, rhodium, palladium, osmium, iridium, titanium, carbon, conductive plastic, or combinations thereof.

5. The system of claim 1, wherein the anode comprises a mixed metal oxide.

6. The system of claim 1, wherein the tank further comprises a conveyor system to remove the flocculated organic material from the surface of the tank.

7. The system of claim 1, wherein the tank electrodes further comprise an inner electrode and an outer electrode, the inner electrode comprising a non-donating conductive material, the outer electrode configured to sheath the inner anode, and the outer electrode configured with a plurality of apertures.

8. A system for purifying wastewater comprising:
a mechanical separation unit structured to remove large particulates from wastewater influent, whereby the wastewater influent is converted to a grossly filtered product that is then entrained to a mixing tank;
the mixing tank comprising a static mixer structured to combine the grossly filtered product with one of an basic pH modifier and/or coagulant selected from a list of sodium hydroxide, an chemical agent and coagulant;
a pump structured to receive the grossly filtered product combined with the basic pH modifier and/or coagulant and transfer the combination into a reactor tube, the reactor tube comprising an outer cathode and an inner anode, the inner anode being positioned centrally within the outer cathode such that a space exists between an outer surface of the inner anode and an inner surface of the outer cathode, wherein the pH modified and grossly filtered wastewater product is moved through the reactor tube and exits through a reactor tube output;
an organic removal flotation tank structured to receive a wastewater flowing through the reactor tube and out the reactor tube output, wherein the flotation tank comprises a plurality of electrodes configured to generate gas bubbles, and structured to separate the mixed wastewater product into dewatered organic material and effluent aqueous solution, the effluent aqueous solution devoid of organic material, wherein the effluent aqueous solution is transferred to a tank;
an injector configured to inject an acidic solution into the tank to decrease the pH of the suspension;
a pH sensor disposed within the tank and configured to monitor a pH of the suspension;
a second pump structured to move the pH modified suspension from the tank through a second static mixer structured to mix the acid with the suspension into a second reactor tube;
the second reactor tube comprising an outer cathode and an inner anode, the inner anode being positioned centrally within the outer cathode such that a space exists between an outer surface of the inner anode and an inner surface of the outer cathode;
wherein a voltage differential applied across the outer cathode and the inner anode is structured to facilitate ammonia removal in the absence of competing organic material; filtered aqueous wastewater product is moved through the reactor tube and exits through a reactor tube output; and
an oxidation chamber receiving effluent wastewater product exiting the second reactor tube output, the oxidation chamber comprising a plurality of electrodes coated by a mixed metal oxide configured to generate gas bubbles, and structured to separate the mixed wastewater product into dewatered organic sludge and effluent aqueous solution devoid of ammonia products and chlorinated disinfection byproducts.

9. The system of claim 8, further comprising an anaerobic digester structured to receive organic sludge from the first reactor tube, and/or second reactor tube.

10. The system of claim 8, further comprising a filtration system disposed between the first reactor tube and the tank structured to clarify effluent from the first reactor tube, removing additional organic material from solution prior to transferring treated wastewater into the tank.

11. The system of claim 8, wherein the acid added to aqueous solution prior to the second reactor tube is an acid comprising HCL, HNO₃, H₂SO₄, HBr, HI, and HCIO₄ moving the pH of the solution resident in the tank to a range between 5 and 7.5.

12. The system of claim 8, wherein the mechanical screen is selected from a list comprising a screw press, clarifiers, settling tanks, and sand filtration.

13. The system of claim 8, further comprising an ultra-filtration system selected from a list comprising reverse osmosis to increase purity of water being discharged as effluent from the oxidation chamber.

14. The system of claim 8, wherein the spacing between the outer surface of the inner anode and the inner surface of the outer cathode in the reactor tube is between about 1 mm to about 9 mm.

15. The system of 8, wherein the inner anode of the reactor tube comprises a non-donating conductive material selected from a list comprising platinum, ruthenium, rhodium, palladium, osmium, iridium, titanium, carbon, conductive plastic or combinations thereof.

16. The system of claim 8, wherein the outer cathode of the reactor tube comprises a non-donating conductive material comprises platinum, ruthenium, rhodium, palladium, osmium, iridium, titanium, carbon, conductive plastic, or combinations thereof.

17. The system of claim 8, wherein the electrodes present in the holding tank and/or the oxidization chamber comprises a mixed metal oxide.

18. The system of claim 8, wherein the base solution comprises sodium hydroxide modifying the pH of the solution to above 7.0 to introduction of the solution into the second reactor tube.

19. The system of claim 8, wherein the effluent aqueous solution from the oxidization chamber is transferred to an optional media filter system comprising carbon filter, ultrafiltration, and reverse osmosis, allowing the remaining organic matter and ammonia byproducts to be transferred to the anaerobic digester.

20. A dual stage method for purifying wastewater comprising:
introducing a chemical to wastewater selected from a list comprising a chemical coagulating agent, and a pH modifier of the incoming wastewater;
flowing the wastewater containing the chemical coagulating agent and/or pH modifier through a reactor tube comprising mixed metal oxide anodes for the reduction of organic matter and biorefractory aqueous pollutants;
allowing the wastewater to then flow into an organic removal flotation tank structured to receive a wastewater flowing through the reactor tube from a reactor tube output, wherein the flotation tank comprises a plurality of electrodes configured to generate gas bubbles, and structured to separate the mixed wastewater product into dewatered organic material and effluent aqueous solution, the effluent aqueous solution devoid of organic material, wherein the effluent aqueous solution is transferred to a tank;
injecting a second pH modifier into the tank to control the pH of the aqueous effluent suspension;
allowing the pH modified aqueous suspension to flow through a second reactor tube comprising an outer cathode and an inner anode, the inner anode being positioned centrally within the outer cathode such that a spacing exists between an outer surface of the inner anode and an inner surface of the outer cathode, wherein a voltage differential applied across the outer cathode and the inner anode is structured to facilitate ammonia removal in the absence of competing organic material;
allowing filtered aqueous wastewater product to move through the second reactor tube and exits through a second reactor tube output; and
receiving effluent treated aqueous wastewater in an oxidation chamber as it exits the second reactor tube output, the oxidation chamber comprising a plurality of electrodes comprising mixed metal oxide coated electrodes configured to generate gas bubbles, and structured to separate the mixed wastewater product into dewatered organic sludge and effluent aqueous solution devoid of ammonia products and chlorinated disinfection byproducts.
